(19) United States
(12) Patent Application Publication
(10) Pub. No.: US 2025/0055835 A1
(43) Pub. Date: Feb. 13, 2025

(54) VIRTUAL BROWSER IN RENDERER COMPONENT

(71) Applicant: INTRUSION INC., Plano, TX (US)

(72) Inventors: Tommy Joe HEAD, Hebron, TX (US); Blake DUMAS, Allen, TX (US); Lauren HEAD, Hebron, TX (US); Jeremy HAMLYN, Adelaide (AU); Jay PICKETT, The Colony, TX (US); Max THOMAS, Carrollton, TX (US); Stephen BLYSTONE, Carrollton, TX (US); S. Tanner KLINE, McKinney, TX (US); A. Benjamin GARTON, Newtown (AU); Adam JENLINS, Adelaide (AU)

(21) Appl. No.: 18/232,240

(22) Filed: Aug. 9, 2023

Related U.S. Application Data
(60) Provisional application No. 63/392,035, filed on Jul. 25, 2022.

(51) Int. Cl. H04L 9/40

(52) U.S. Cl. CPC H04L 63/0281; H04L 63/101; H04L 63/14

(57) ABSTRACT

Systems, methods, apparatuses, and computer program products for displaying content on a user device that is rendered at a remote device. One method may include detecting, by a computing device, a selection of a first object by a user, transmitting, by the computing device, a request to a rendering device to render the first object and begin a viewing session; and receiving, by the computing device, a rendering of the first object from the rendering device.

### CROSS-REFERENCE TO RELATED APPLICATION

This application claims the benefit of U.S. Provisional Application No. 63/392,035 filed on Jul. 25, 2022, which is entirely incorporated herein by reference.

### FIELD

Some embodiments may generally relate to secure computer browsing technologies, and more particularly to a system and method for displaying content on a user device that is rendered at a remote device.

### BACKGROUND

A significant number of current malware attacks by malware developers depend on tricking end users into navigating to apparent websites, network resources, and unintended uniform resource identifiers (URIs) that host zero-day exploits and drive-by-download attacks. Such zero-day exploits and drive-by-download attacks are typically undetected by conventional anti-virus and anti-malware technologies, even though such attacks are often capable of compromising many users' devices, personal accounts, and information in rapid fashion. Alternatively, if such zero-day exploits and drive-by-download attacks are detected by conventional anti-virus and anti-malware technologies, the users may be provided with an option to remove such detected malware, usually after the malware has been downloaded to the user's device. In some instances, the users may disregard the notice received from such conventional anti-virus and anti-malware technologies. Conventionally, proxy devices may be used to mitigate this issue. Such proxy devices, however, display their internet protocol (IP) addresses to the malware servers, and may allow the zero-day exploits and drive-by-download attacks to reach their target. Another drawback with proxy devices is that they lack information about every URI that exists on the Internet or elsewhere, and, as a result, such a solution dramatically reduces a user's ability to browse unknown URIs that are actually benign in nature. Proxy solutions may display a warning web page on a user's internet browser whenever a user attempts to navigate to an unknown URI; however, such warning web pages typically require some interaction with or acceptance by the user before the user proceeds to their intended destination. While this solution may provide some awareness of potential malware to the user, the security decision is left to the user. By providing the user with the option to navigate to the unknown URI, the user has the opportunity to accept the risk to proceed and navigate to a potentially malicious website that is associated with the unknown URI. Accordingly, there is a need for a secure browsing solution that does not place the security decision for recognizing and avoiding malware with the user.

In the technical field of network security, an “air gap” can provide the highest level of security by physically disconnecting a user device from all wired and wireless connections, thereby protecting the user device from malware from outside actors. For example, an air gap could prevent malware embedded within email attachments and websites from ever reaching and infecting the user device. Similarly, an air gap could also prevent malware on an air gapped, new user device from being passed onto other devices, such as those within the same corporate network. However, an air gap also has the disadvantage of prohibiting desired inbound and outbound network activity of the user device, and thus is not a practical solution for most applications. Certain embodiments described below allow a protected device to gather the benefits of being air gapped while being able to fetch, see, log, and curate unsafe content by use of an intermediate device, referred to as a renderer, that performs the fetching, logging, curating, and possible execution of the potentially unsafe content, and rendering the results to the protected device for display to the user or other use by the protected device.

Two of the most common sources of malware are websites and email attachments. While browsing websites, a browser on a user device may load a website which includes hidden trojans or malware (e.g., source (SRC) links, JavaScripts, hyperlink references (HREFs)) that are loaded onto the user device. Although user devices frequently detect malware using specifically-designed software (e.g., anti-virus, anti-malware, phishing protection, etc.), zero-day malware remains an ongoing risk by exploiting novel, unpublished vulnerabilities in user devices. Similarly, user devices may execute and render content and links embedded in emails, potentially exposing the user device to phishing, spear-phishing, and whaling attacks.

A variety of techniques can provide limited protection in preventing the spread of malware onto user devices. For example, proxies may be used to block websites that are known to spread, or potentially spread, malware onto user devices. However, upon visiting such websites, proxies frequently provide security notifications to user devices regarding the potential risks in visiting flagged URIs, but leave the final decision to users on whether to load the URI. These notifications may leave users unclear as to whether the flagged URI is actually blocked or merely unavailable; whether a network connectivity problem is preventing access to the flagged URI; whether the user requested the correct URI; and whether the user should access the URI on a different device (e.g., personal mobile device) that is unequipped to filter for malware.

Other techniques, such as domain name system (DNS) sink-holing, can prevent users from connecting to dangerous sites by blocking access to malware sources using DNS- or IP-blocking, as shown in FIG. 1. Yet, as noted above, this may lead users to believe that the source is unavailable due to a failure to connect.

Further, website browsing and a desire to protect and control DNS filtering has led to the development of DNS over Hypertext Transfer Protocol Secure (HTTPS) (DoH), Domain Name System Security Extensions (DNSSEC), and Domain-Over-TLS (DOT). For example, FIG. 2 illustrates an example of a network architecture used by a corporation to protect employees from malicious URIs. The corporate DNS resolver may provide sink-holing of malicious URIs, where all network traffic passes across the corporate boundary through, for example, a firewall, proxy, and/or intrusion detection and prevention system (IDPS), each designed to block malware. Although these tools may first redirect users to block pages, certificate pinning and HSTS (HTTP strict transport security) may prevent users from being redirected to the block page altogether, or give users the option to accept the risk of the detected malware and proceed with connecting.

DNS (as in FIG. 2), HTTP redirects, or other similar methods used to redirect a user device to a block/redirect page can create challenges with certificate pinning. For example, before a user device displays a block/redirect page, browser security warnings may indicate to the user that the requested page is unsafe and does not pass security requirements, and/or the user device may never display the block/redirect page. These browser security warnings may provide users with the option to accept the risk and proceed anyway, without providing a full explanation as to the reasons why the requested page did not pass the security requirements. Users may then unknowingly expose the network to malware detected by the DNS or HTTP redirect.

FIG. 3 depicts an example of a proxy separating a user device and a server outside of the boundary of the network, allowing the network to log activity, prevent exfiltration of corporate data, and prevent introduction of malware. As a result, the proxy interrupts the encrypted session between the user device and the server. The user device may use trusted certificates to use the proxy; however, in responding to man-in-the-middle (MITM) attacks, websites are increasingly using certificate pinning, which may prevent a proxy from being inserted between a user device and a certificate-pinned server. In light of certificate pinning, proxies may be forced to simply allow HTTPS sessions to pass through without monitoring or control, creating new vulnerabilities (e.g., activity concealed with port 443/secure socket layer (SSL) encrypted sessions or other tunneled or hidden communications).

Remote desktop protocol (RDP) is an example of a standards-based protocol that provides a graphical interface for connecting to another computer over a network connection. RDP may be conventionally used to connect to a virtual or separate physical machine, which may then be used for remotely accessing websites. Although this may separate the user device from the remote virtual machine for the current website session, this technique requires an excessive and unsustainable amount of bandwidth (e.g., 3X) in order to transmit data from the website source to the remote virtual machine, and then to the user device. RDP license availability can also limit the number of accessible or simultaneous sessions available to the users. RDP sessions may also offer limited functionality, creating challenges with tracking with RDP, as well as user confusion regarding whether information is stored on the virtual machine or the user device. Previous techniques have related to using a remote machine full-time for safe surfing, which can be expensive and often slower than native work, while still leaving native browsers in play on the local machine which represents a threat from “window confusion” between clean and dirty windows. To address these disadvantages, various example embodiments may provide a transparent way of performing low risk actions locally and higher risk activities remotely. Thus, some example embodiments may be responsive to a change in how web security has been implemented, in that redirection by DNS and HTTP has become highly risky (e.g., being silently redirected to a malicious site) that redirect methods like this for protecting a user may not always be successful; in addition, fewer redirections may work as websites implement certificate pinning and other protection methods along with browser security upgrades. One of the novel aspects of some example embodiments is the use of a browser plug in or adding function to the browser to address these disadvantages.

A remote session to a virtual machine may be a continuous, dynamic connection rather than transactional, leaving security decisions about whether a virtual machine (VM) is necessary to the user. In addition, utilizing an entire virtual machine for each user means that fewer users may be accommodated per real server, increasing operational costs. Cloning a virgin virtual machine also requires additional resources, causing virtual machines to be used longer than necessary. A full virtual machine configured to perform more functions than required results in slower and more vulnerable service, compared to a VM that is hardened and streamlined for specific functions.

Because network security measures may have frequent false positives on safe URIs, users may remain skeptical as to whether security notifications are reliable and should be heeded. This may encourage users to generally ignore such security notifications, even though a single intrusion by malware can cause significant damage to user devices and/or an entire computer network.

More recently, websites are prohibiting visitors from viewing content unless users disable their advertisement blocking software on user devices, opening another opportunity for malware to enter onto a user device. For example, advertisements, source links, and HREFs in advertisements may have embedded malware and/or other exploits.

### SUMMARY

In accordance with some example embodiments, a method may include detecting, by a computing device, a selection of a first object by a user. The method may further include transmitting, by the computing device, a request to a rendering device to render the first object and begin a viewing session. The method may further include receiving, by the computing device, a rendering of the first object from the rendering device.

In accordance with certain example embodiments, an apparatus may include means for detecting a selection of a first object by a user. The apparatus may further include means for transmitting a request to a rendering device to render the first object and begin a viewing session. The apparatus may further include means for receiving a rendering of the first object from the rendering device.

In accordance with various example embodiments, a non-transitory computer readable medium comprising program instructions that, when executed by an apparatus, cause the apparatus to perform at least a method. The method may include detecting a selection of a first object by a user. The method may further include transmitting a request to a rendering device to render the first object and begin a viewing session. The method may further include receiving a rendering of the first object from the rendering device.

In accordance with some example embodiments, a computer program product may perform a method. The method may include detecting a selection of a first object by a user. The method may further include transmitting a request to a rendering device to render the first object and begin a viewing session. The method may further include receiving a rendering of the first object from the rendering device.

In accordance with certain example embodiments, an apparatus may include at least one processor and at least one memory storing instructions that, when executed by the at least one processor, cause the apparatus at least to detect a selection of a first object by a user. The at least one memory and instructions, when executed by the at least one processor, may further cause the apparatus at least to transmit a request to a rendering device to render the first object and begin a viewing session. The at least one memory and instructions, when executed by the at least one processor, may further cause the apparatus at least to receive a rendering of the first object from the rendering device.

In accordance with various example embodiments, an apparatus may include detecting circuitry configured to perform detecting a selection of a first object by a user. The apparatus may further include transmitting circuitry configured to perform transmitting a request to a rendering device to render the first object and begin a viewing session. The apparatus may further include receiving circuitry configured to perform receiving a rendering of the first object from the rendering device.

In accordance with some example embodiments, a method may include receiving, by a computing device, a filetype decomposed from a rendering device. The method may further include rendering, by the computing device, the decomposed filetype.

In accordance with certain example embodiments, an apparatus may include means for receiving a filetype decomposed from a rendering device. The apparatus may further include means for rendering the decomposed filetype.

In accordance with various example embodiments, a non-transitory computer readable medium comprising program instructions that, when executed by an apparatus, cause the apparatus to perform at least a method. The method may include receiving a filetype decomposed from a rendering device. The method may further include rendering the decomposed filetype.

In accordance with some example embodiments, a computer program product may perform a method. The method may include receiving a filetype decomposed from a rendering device. The method may further include rendering the decomposed filetype.

In accordance with certain example embodiments, an apparatus may include at least one processor and at least one memory storing instructions that, when executed by the at least one processor, cause the apparatus at least to receive a filetype decomposed from a rendering device. The at least one memory and instructions, when executed by the at least one processor, may further cause the apparatus at least to renderer the decomposed filetype.

In accordance with various example embodiments, an apparatus may include receiving circuitry configured to perform receiving a filetype decomposed from a rendering device. The apparatus may further include rendering circuitry configured to perform rendering the decomposed filetype.

In accordance with some example embodiments, a method may include receiving, by the computing device, a rendering from a rendering device, wherein the rendering comprises at least one service. The method may further include terminating, by the computing device, a local service on the computing device that corresponds with the at least one service of the rendering device.

In accordance with certain example embodiments, an apparatus may include means for receiving a rendering from a rendering device, wherein the rendering comprises at least one service. The apparatus may further include means for terminating a local service on the computing device that corresponds with the at least one service of the rendering device.

In accordance with various example embodiments, a non-transitory computer readable medium comprising program instructions that, when executed by an apparatus, cause the apparatus to perform at least a method. The method may include receiving a rendering from a rendering device, wherein the rendering comprises at least one service. The method may further include terminating a local service on the computing device that corresponds with the at least one service of the rendering device.

In accordance with some example embodiments, a computer program product may perform a method. The method may include receiving a rendering from a rendering device, wherein the rendering comprises at least one service. The method may further include terminating a local service on the computing device that corresponds with the at least one service of the rendering device.

In accordance with certain example embodiments, an apparatus may include at least one processor and at least one memory storing instructions that, when executed by the at least one processor, cause the apparatus at least to receive a rendering from a rendering device, wherein the rendering comprises at least one service. The at least one memory and instructions, when executed by the at least one processor, may further cause the apparatus at least to terminate a local service on the computing device that corresponds with the at least one service of the rendering device.

In accordance with various example embodiments, an apparatus may include receiving circuitry configured to perform receiving a rendering from a rendering device, wherein the rendering comprises at least one service. The apparatus may further include terminating circuitry configured to perform terminating a local service on the computing device that corresponds with the at least one service of the rendering device.

In accordance with some example embodiments, a method may include transmitting, by a computing device, a request to a rendering device to render a first object and begin a viewing session. The method may further include receiving, by the computing device, data from the first object. The method may further include transmitting, by the computing device, the data from the first object to the rendering device. The method may further include receiving, by the computing device, a rendering of the first object from the rendering device.

In accordance with certain example embodiments, an apparatus may include means for transmitting a request to a rendering device to render a first object and begin a viewing session. The apparatus may further include means for receiving data from the first object. The apparatus may further include means for transmitting the data from the first object to the rendering device. The apparatus may further include means for receiving a rendering of the first object from the rendering device.

In accordance with various example embodiments, a non-transitory computer readable medium comprising program instructions that, when executed by an apparatus, cause the apparatus to perform at least a method. The method may include transmitting a request to a rendering device to render a first object and begin a viewing session. The method may further include receiving data from the first object. The method may further include transmitting the data from the first object to the rendering device. The method may further include receiving a rendering of the first object from the rendering device.

In accordance with some example embodiments, a computer program product may perform a method. The method may include transmitting a request to a rendering device to render a first object and begin a viewing session. The method may further include receiving data from the first object. The method may further include transmitting the data from the first object to the rendering device. The method may further include receiving a rendering of the first object from the rendering device.

In accordance with certain example embodiments, an apparatus may include at least one processor and at least one memory storing instructions that, when executed by the at least one processor, cause the apparatus at least to transmit a request to a rendering device to render a first object and begin a viewing session. The at least one memory and instructions, when executed by the at least one processor, may further cause the apparatus at least to receive data from the first object. The at least one memory and instructions, when executed by the at least one processor, may further cause the apparatus at least to transmit the data from the first object to the rendering device. The at least one memory and instructions, when executed by the at least one processor, may further cause the apparatus at least to receive a rendering of the first object from the rendering device.

In accordance with various example embodiments, an apparatus may include transmitting circuitry configured to perform transmitting a request to a rendering device to render a first object and begin a viewing session. The apparatus may further include receiving circuitry configured to perform receiving data from the first object. The apparatus may further include transmitting circuitry configured to perform transmitting the data from the first object to the rendering device. The apparatus may further include receiving circuitry configured to perform receiving a rendering of the first object from the rendering device.

### BRIEF DESCRIPTION OF THE DRAWINGS

For a proper understanding of example embodiments, reference should be made to the accompanying drawings, wherein:

FIG. 1 illustrates an example of a corporate boundary separating a user device and server.

FIG. 2 illustrates an example of a corporate boundary separating a user device used in conjunction with a corporate DNS resolver and block page from a server.

FIG. 3 illustrates an example of a proxy server separating a user device from a server.

FIG. 4 illustrates an example of a renderer separating a malicious server from a user device used in conjunction with a safe server.

FIG. 5 illustrates a renderer providing a virtual browser that separates a data center from a user device.

FIG. 6 illustrates an example of a flow diagram of a method according to various example embodiments.

FIG. 7 illustrates an example of a signaling diagram according to certain example embodiments.

FIG. 8 illustrates an example of various devices according to some example embodiments.

### DETAILED DESCRIPTION

It will be readily understood that the components of certain example embodiments, as generally described and illustrated in the figures herein, may be arranged and designed in a wide variety of different configurations.

The features, structures, or characteristics of example embodiments described throughout this specification may be combined in any suitable manner in one or more example embodiments. For example, the usage of the phrases “certain embodiments,” “an example embodiment,” “some embodiments,” or other similar language, throughout this specification refers to the fact that a particular feature, structure, or characteristic described in connection with an embodiment may be included in at least one embodiment. Thus, appearances of the phrases “in certain embodiments,” “an example embodiment,” “in some embodiments,” “in other embodiments,” or other similar language, throughout this specification do not necessarily refer to the same group of embodiments, and the described features, structures, or characteristics may be combined in any suitable manner in one or more example embodiments.

Additionally, if desired, the different functions or steps discussed below may be performed in a different order and/or concurrently with each other. Further, if desired, one or more of the described functions or steps may be optional or may be combined. As such, the following description should be considered as merely illustrative of the principles and teachings of certain example embodiments, and not in limitation thereof.

Certain example embodiments described herein may have various benefits and/or advantages to overcome the disadvantages described above. For example, certain example embodiments may protect all communications, not just HTTP. Thus, certain example embodiments discussed below are directed to improvements in computer-related technology. For example, some embodiments may overcome the disadvantages caused by DNS and HTTP redirection, while also removing the human error problems of window confusion between the local and remote browser of previous solutions. When a URI is accessed, including by selecting, typing, or fetching by a script-some embodiments may check if the URI should be rendered remotely, then use a script or click to automatically originate that request on the remote renderer, eliminating DNS or HTTP redirect. Further, certain embodiments may provide a transaction transparent to the user in a native web browser. As a result, dangerous URIs that were automatically opened in the default browser are first checked, blocked, and then automatically sent to the remote renderer while the user barely notices anything has happened; the user only sees requested information in a normal browser or browser tab, which was opened and rendered remotely.

Further, if the user is currently viewing a remotely rendered (unsafe) page, although this configuration may require some remote resources and bandwidth resources, the user will still be protected. However, when the user accesses an unsafe page in the remote renderer and clicks on something safe, there is no reason to stay in the remote renderer for safe activities. Some embodiments may check both local requests and remote renderer requests such that unsafe local requests are rendered remotely, but safe requests made on the remote renderer are transparently passed back to the local browser and fetched locally. Thus, if the user accesses a link to a safe video on an unsafe site rendered remotely, clicking on that link may cause the video to be sent directly to the local browser for maximum efficiency since it is safe.

Various embodiments also solve the problems posed by user error and automatic HTTP fetches using the system's default browser. When a client uses a remote desktop connection to a remote virtual server for rendering web content, there is a constant threat of a windowpane selection error, which can expose the user and the enterprise to compromise. A browser in a remote desktop session and a native local browser may appear the same; if a dangerous site is opened in the safe window and the local browser is accidently selected, the local computer is compromised. In another threat scenario, there may be a local machine's default browser. The security problem presented in this case is when an email, document, presentation, or other page is opened which contains a link. If opened, it may not open in the remote desktop, and instead open in the local default browser and potentially compromise the machine and enterprise. The back and forth feature described above means that there is never a bad place to open an unsafe link. That is because in this solution, the default browser may have provided protection. If any application on the system opens an HTTP page, the reputation and trust check on the URI by some embodiments may determine if the link is trusted or not—and automatically open it on the remote renderer if it is not trusted enough to open locally.

Certain embodiments of the renderer invention may be particularly effective with The Onion Router (Tor) clients with respect to anonymity and security. Tor is a protocol that supports anonymous communication between user devices and servers, and minimizes traceability, raising the probability for user devices to encounter malware. The claimed renderer may mitigate the increased risk of using Tor clients by only rendering content on the dedicated renderer, while also concealing the identity of the user device while protecting it from malicious content.

Some embodiments may also overcome the drawbacks of using a proxy. As discussed above, proxies may be placed where filtering could remove malware while keeping the user device safe; however, proxies may be used in furtherance of MITM attacks, which allow hostile parties to decrypt sessions and embed spyware on the user device. Certificate pinning has been increasingly deployed to prevent the use of proxies. With pinning, the browser cannot be forced to connect to a website, which is not the real endpoint because a proxy or MITM attack cannot spoof the cryptographic signing of the correct certificate. Thus, certain example embodiments discussed below are directed to improvements in computer-related technology.

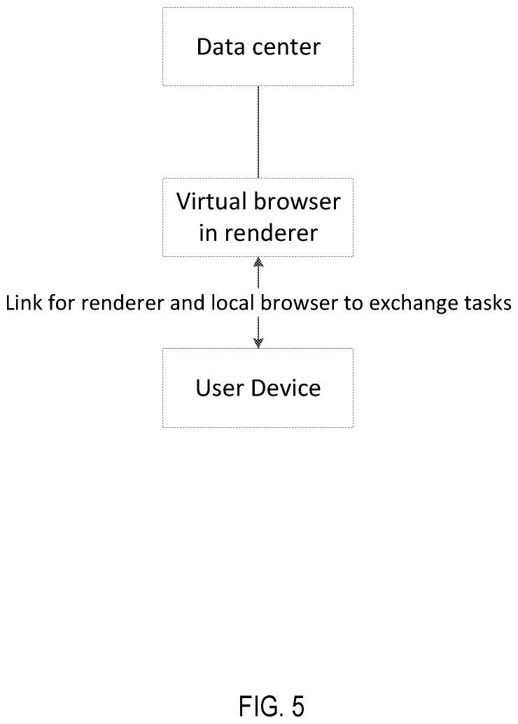

As explained above, when a user device connects to a server on the internet (e.g., mail server, web server, video server), the requested content is transmitted to, and rendered on, the user device. To address the challenges posed by this technique, some example embodiments described herein enable URIs to be safely rendered on a user device or on a rendering machine that is isolated from the user device, such as with an armored reverse proxy (i.e., the renderer does not see or know the IP address of the client so that, if compromised, the identity of the user is not knowable to sites visited). In particular, a renderer may be placed between the user device and servers on the internet, as shown in FIG. 5, preventing any potential malware from being loaded and executed on the user device. The front end and back end of the browser on the user device are separated (e.g., by plug-in or browser architecture) so that the URI may be passed back and forth between the user device and remote renderer such that all connections are proper to the current/real web resource. By separating the user interface front end from the rendering back end, a plug-in or custom browser can be inserted so that the selected URI can be either rendered locally or sent to the remote renderer for fetching and rendering. As a result, there is a constant back-and-forth between the local browser and the remote renderer. In addition to web browsing, many common internet-based threats may be addressed by various example embodiments described herein, such as emailing more secure. For example, with traditional email thick clients, email messages are downloaded to a local machine. When the email is opened, active content and links may only be fetched and processed on the local machine, thereby exposing your device and network to virtually unlimited threats, including zero days and other undetectable threats. However, when certain example embodiments are used to fetch email via a webmail or other app running on the renderer, no email content may be fetched or rendered on the local machine, eliminating many threats and entry vectors from entry into the local environment. In this way, a user can receive and read data without reaching the local machine but can still use it safely. Some example embodiments may also be used to protect a user viewing any type of document or object which can contain macros, code, and call homes. This may include business document editors and readers by running those applications and loading those documents or objects on the renderer rather than the local unprotected device. This removal from local isolation also dynamically prevents other security risks such as clipboard leaks and complex privacy and location privacy issues like browser, operating system, application, device, location, persona, platform, vehicle, and behavior fingerprinting.

Any potential malware would be executed only on the renderer, and the user can access any URIs desired (even URIs known to contain malware) without being blocked or downloading malware. The renderer may be a fully-instrumented sandbox, where malware can be catalogued, observed, summarized, and/or retained for forensic analysis. The renderer may support file downloads via a number of different methods including file transfer protocol (FTP), server message block (SMB), HTTP(S), software and firmware updates, file sharing methods such as bittorrent, web surfing via TOR, and whole classes of applications which can leak data via less trusted platforms.

In various example embodiments, the renderer may be a trusted, zeroed client (i.e., no persona nor machine identities) and/or branded client with some desired persona. User devices frequently have tracking identifiers (e.g., cookies, registry entries, other benchmarks) that may be used to identify individual user devices, their activities, and their users. By respawning the renderer after each session, such tracking identifiers do not survive after the user finishes using the renderer.

Further, a page rendering subcomponent of the renderer permits downloading, running, and building of a page view without identification information of the user device. In particular, the page rendering subcomponent does not possess the IP address, hostname, or other identifiers of the user device in order to avoid this information being acquired by malware. For example, emails may be read on the renderer on the page rendering subcomponent using a webmail client, thereby preventing malware embedded in attachments from spreading to the user device. Although the renderer may be executed within a virtual machine on a user device, security is greatly improved by executing the renderer on a separate device to isolate any malware from the physical user device. In some example embodiments, a reverse proxy may be used, such that the renderer knows to send the results to an identifier (ID), but not the IP, device name, or any attribute of the actual client. An ID may be generated randomly, only used to do a match in a reverse proxy and route it to the proper encrypted tunnel that is eventually provided to the remote client. Further, there may be an encrypted relay separate from the reverse proxy to further isolate the user from the renderer.

In some example embodiments, the corporation may require that its infrastructure is not used for illegal purposes or purposes other than the business of the corporation, and generate activity logs that confirm conforming behavior. This may be preferable over Tor since organizational standards and protections are optional. For example, if an anonymous service is used, the rendering session may allow organizational rules to be applied. For example, organizational rules may include, a school that blocks pornography, child pornography, etc.; an organization that blocks illegal or gambling sites, with or without logging of users attempting to access them; a corporation that prevents its rendering operation from being used to launch attacks against other organizations, nations, or other targets; the renderer includes a variety of logging methods to allow the system to retain encrypted logs of connections, indicating particular users and visited site. The organization could allow banking without just blindly also allowing unlimited outflow of company secrets to a bank used as a relay for secrets. This may follow standards of ethical AI, where the system cannot retain private data but can inspect data exfiltration in real time without breaking encryption or exposing employee data. As an example, ethical AI may refer to a construct on how to set up boundaries for AI to protect privacy. For example, a piece of code may be designed to inspect clear text for company proprietary information, but not allow it to record, retain, or copy data which does not trigger the plagiarism or stolen content rules of the AI. Thus, if an employee was doing banking, the organization cannot retain his banking records, but the AI could alert when company secrets were being pushed to the bank in a covert theft attempt.

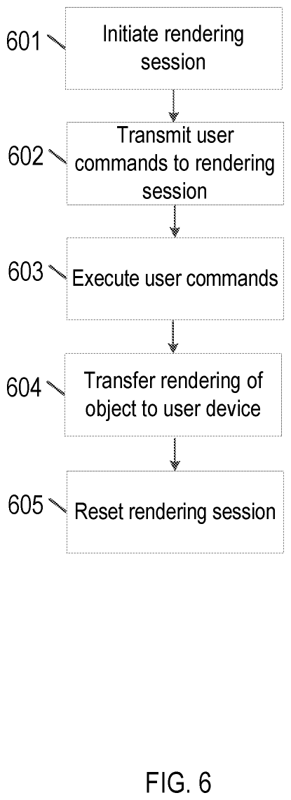

FIG. 6 illustrates an example of a flow diagram of a method that may be performed by a computing device.

At 601, a rendering session is initiated, and connects directly to a requested object (e.g., URI). The rendering session may be a virtual browser, and may be initiated by a user selecting a destination link (e.g., object) on a user device which has been identified as failing predetermined security conditions. The selection of the destination link may be transparently transmitted between the renderer and the rendering session.

In some example embodiments, the predetermined security conditions may include a block list and/or an allow list. Additional predeterminations may be policy-based for customers, and entities may be blocked according to the location or nationality of the entity. Some of these predetermined security conditions may be behavior or AI-based conditions such as call-homes, answered call homes, data exfiltration, or inappropriate roles. In some embodiments, the presence or use of certain JavaScripts or other executables, content, or content handlers may be associated with unexpected or undesirable behavior, and may override a previous “trust” rating. Thus, if corporations are monitored globally and are attacked, a demotion in trust may be triggered for other similar entities despite the similar entities not being directly affected.

In various example embodiments, a site may be rendered or run on a downloadable application, rendered in a local sandbox, or only at the renderer to protect the user's personal data, including name, location, movements, friends, traveling associates, etc. from an application vendor. By running the application in a sandbox, the application does not have the ability to reach out and read global positioning system (GPS) data, the registry, the international mobile equipment identity (IMEI), various cookies, mobile advertising identifier (MAID), etc. which may violate the privacy of the user. As an example, if the sandbox is local to the user, security may depend on the ability of the sandbox to prevent code running inside it from escaping to the outer operating system. For the most conservative approach, the remote sandbox may be the most secure because if code or a hostile adversary ever escapes the sandbox, the outer environment is separated from the local machine and has no personal or location data to divulge. For example, on a mobile phone or tablet, where the operating systems are not impenetrable and if it were to run a sandbox on it, the security consequences of escaping the sandbox could give an adversary access to location, phone number, contacts, history, call history, and more. However, using a remote sandbox would be far safer in the event of a breach of the sandbox, as a sandbox in a remote data center has no identification or location information.

In some example embodiments, the rendering session may be linked to the client via a viewing session (e.g., using remote desktop protocol (RDP), VNC). In some example embodiments, the viewing session may be configured for human viewing. For machine consumption, a viewing session may leverage object observables, hashes and checksums, perceptual hashes, cryptographic checksums, file attributes, contextual topics and categories and the like.

As discussed herein, a viewing session may be similar to, but is not limited to, using a method like RDP or VLC. Further, a “renderer” or “rendering device” may be implemented as a remote instance, which may not be on the same device as the client, as more than one remote instance, more than one performing different functions or constructing a scalable parallel architecture, or as a service running locally on the protected device with some appropriate isolation mechanisms. Likewise, a “viewing session” may not be limited to a human “user” viewing content on a screen, but the “user” may include a variety of consumers of content that are code, databases, machine learning, comparison, de-duplication, pattern recognition, and other functions implemented by various firmware, software, and hardware mechanisms.

In certain example embodiments, the user device may receive, from a user, input to open an object, such as clicking on a link, and/or entering an object. The user device may determine whether the requested object fails predetermined security criteria. For example, the predetermined security criteria may include a reputation of the requested object, a series of DNS questions and answer (e.g., canonical name (CNAME) chain), and/or redirects.

At 602, the user device may transmit user commands input into the user device to the rendering session. For example, a user command selecting that an email attachment be opened is passed to the rendering session. Only the browser of the user device knows the object that was input by the user, which may be selected from a list, offered by a script, or pasted in. This data may not be available from the network nor via DNS.

In certain example embodiments, a DNS request for a blocked domain may return an IP address (or a CNAME) of the renderer to the user device, which may optionally be a 2-step redirect to allow for the insertion of secondary authentication. The renderer may know if the user device is a legitimate user of the safe rendering service. In addition, the browser of the user may believe that the renderer is the requested website they wanted, and automatically request the object from the user device. This method may use a DNS or HTTP redirect method. The client's browser may point to the renderer and make its original (blocked) request known to the renderer; in turn, the renderer may fetch, render, and return the results safely to the client. In cases where certificate pinning is used by the desired website URI, the redirection may not work since the renderer is known by the client's browser to not be the desired website—in which case the renderer cannot know what site to render. In addition, the client's browser may refuse content from the renderer since it is assumed to be a MITM hostile website attempting to spoof the end site. The renderer may be configured to allow a smart agent on the client to send the blocked object (or other object locator) directly to the renderer, thereby avoiding the certificate pinning problem. This technique may avoid the disadvantages associated with certificate pinning in a novel way; since redirects may not be successful, the smart agent on the client may not be redirected to the renderer. Instead, the object (or other object locator) desired by the client may be seamlessly transmitted to the renderer so that the original request comes from the renderer—and the results are then shown remotely on the client.

The renderer may receive malware in response to the object request; execute the malware; fetch HREFs, SRC links, and scripts; and be configured to render the page as hypertext markup language (HTML) on the user device. The rendered page may include banners, borders, or other notation to notify the user that the site is unsafe and has been safely and remotely rendered. When the user device receives subsequent input from the user on the remotely rendered page, these functions may have a few security exceptions.

Further, the rendering session may open a browser corresponding with the requested object, including related SRC links present, and render the composite content received from the object. In certain example embodiments, the renderer may enter a full lockdown mode, wherein the network map is severely limited to include only full trust partner devices, and may allow full spyware to be defeated by funneling all traffic through the user device and/or the renderer.

At 603, in response to receiving the user commands from the user device, the rendering session may execute the user commands, and respond to the user device with results occurring due to the user commands. For example, a user command opening an email attachment may cause the rendering session to open the requested email attachment, and respond to the user device with a plurality of rendered items (e.g., forms, video, audio, documents) of what is contained in the email attachment. Similarly, the user commands may include filling out forms, viewing videos, and listening to audio/music.

In some example embodiments, the user device may log activities to ensure that malware is not active on the machine and that private content is not being encrypted or sent out. Further, the renderer may be configured to run applications depending on cost and risk. For example, for the highest risk devices and/or the highest risk content, all web content may run on the renderer, effectively stopping the risk of web content and downloads from infecting the user device. Alternatively, for low risk content on user devices with average value of contents, rendered content may be according to risk. Thus, low risk content may be run on the user device, while higher risk content may be run on the renderer. Since the catalog of global devices and risk is much larger than can be stored on many devices, this risk level is based on secure remote lookups to a global risk/trust database, allowing for switching of modes from local rendering to remote rendering based on risk.

At 604, the rendering session may transfer the rendering of the object to the user device. In some example embodiments, the rendering session and/or the user device may determine whether the executed user command triggers any predetermined security criteria. For example, if the user command triggers embedded code, which does not satisfy any predetermined security criteria, the rendering session may transmit an indication to the user device that the requested user command is safe for execution on the user device. Alternatively, the rendering session may transfer data to the user device that is configured to open and access the requested object. As a result, safe links may be transferred back to the user device, thereby conserving bandwidth, and the browser of the user device only fetches and renders safe content. In contrast, the rendering session may receive and render all content, including unsafe content, since the rendering session is remote from the user device and does not execute on the user device. In certain example embodiments, clients may use the domain name, the hostname, the IP addresses, the source links, called JavaScript, and/or selected HREFs to trigger lookups of trust for the session. Any failed selections may be blocked locally and/or the whole session may be moved to the renderer. For example, if the user clicks on a link that is safe, the rendering may be redirected back to the native browser for local fetch and rendering. However, if the user clicks on another page, which is unsafe, the remote rendering machine may continue to safely render the page.

In various example embodiments, the renderer may stub off each class, type, and instance of executables so that they may be run locally or remotely from the device. This may result from the processing of files created locally/safely on trusted equipment, versus files from outside the trust zone; running apps, which potentially may read or glean more data than is desired from the local machine (so these are safer if run remotely on the renderer); and apps which, by their nature, may access sensitive information to operate when run remotely this can be better controlled.

In certain example embodiments, the user command may include downloading files in any conventional format, such as ADOBE ACROBAT (.pdf), MICROSOFT WORD (.doc, .docx), MICROSOFT EXCEL (.ppt, .pptx), MICROSOFT POWERPOINT (.ppt, .pptx), or any type of data or content.

In addition to specific file types associated with extensions such as these, media servers may also specify Secure/Multipurpose Internet Mail Extensions (SMIME) types to objects as they are presented in a web session, thereby ignoring the file extension. For example, a document filetype (e.g., MICROSOFT WORD) may be specified as a video and played by the browser as a video. Further, many common filetypes may contain various types of both malware and benign scripting. Although virus scanning and/or end point protection can mitigate these risks, zero-day exploits and novel variations of ways to embed hostile code remain a constant threat. With no method to predict new zero-day and unknown exploits, the rendering session may isolate unknowable malware embedded in content as scripts by ensuring that all scripts are removed from downloaded content. Specifically, the rendering session may decompose all content into primitive forms, which cannot contain executable scripts, macros, etc. For example, documents may be decomposed to primitive text or rich text format (RTF), spreadsheets may be decomposed to multiple comma-separated values (CSV) files, drawings may be decomposed to RTF, and/or PDFs may be decomposed to RTF or image files. Thus, “primitive form” may refer to a file type that is saved to a format, which cannot contain executable, macros, and/or code. Further, executable content is rendered so that the output is clean.

Although MICROSOFT Object Linking and Embedding (OLE) can include multiple layers of different types of files and contents buried inside each other, scripts and macros can still be cleaned by the rendering session.

The rendering session may decompose all filetypes, which can contain executable content into simpler forms that cannot contain executable content. For example, MICROSOFT EXCEL files may be decomposed into one or multiple .csv files, while MICROSOFT WORD documents may be decomposed to Rich Text Format (RTF). The rendering session may then transfer these files to the user device, thereby minimizing the risk of malware infecting the user device. The decomposition may create intermediate forms of a file or document, which cannot contain scripts, code, executables, exploits, or communications capabilities. Once decomposed, the user device may then reconstitute primitive formats to the original file type to achieve consistency. In addition, for forensic preservation, the original (non-decomposed) file may be summarized with a 32-character hexadecimal number (e.g., message digest (MD) 5 checksum), or other checksum such as secure hash algorithm (SHA) 1 or SHA256, saved remotely, and/or deleted. For filetypes with inconsistent optical conversion quality, a variety of safely rendered snapshots may supplement the converted file, which may be transferred to the client workstation without risk of malware infecting the user device. Decomposing the files may also lose formatting fidelity. However, a rendered image may be preserved in a safe manner for viewing on the client (or server). Thus, the decomposed file may provide editable text and content, but with a potential loss of formatting. A rendered image may not have such loss of formatting, providing the user with a safe copy of both available. In some situations, the original, malware file may be needed for legal, forensics, research, and/or other reasons, yet the remote renderer may be periodically destroyed. Thus, the original file may be stored and archived on a dirty storage network and/or be encrypted/encapsulated with a key which is unavailable on the clean network, allowing for compromised files to be safely kept on a clean network, since they cannot be decrypted or accessed on the clean network. This may allow content to be safely viewed, as well as to retain the originals to view a rendered version with no filtering remotely, download a passivated version of the file for copy and pasting into various forms, save the fully rendered images with perfect formatting, and retain safe versions in addition to the dangerous original in encrypted form locally or remotely stored dirty storage.

In some example embodiments, some predetermined types of applications (e.g., web browsing, mail, file downloads, form filling, uploads) may automatically be transferred to the rendering device, and never transferred back to the user device.

In certain example embodiments, licensed content is frequently compressed and encrypted, and may only be viewed with a reader downloaded from unknown authors installed on the user device. This type of downloaded content may be safely used with rendering sessions, protecting the user device from infection by the executable.

As shown in FIG. 5, the link between the virtual browser and user device is dynamic, allowing for sessions and link to be freely exchanged based upon their satisfaction of the predetermined security conditions. For example, when the rendering session has an object already open, and the user opens an unsafe object on the user device, the object may remain on the renderer, and may not be transferred to the user device. However, when the user opens a trusted object within the rendering session, the safe object may be transferred back to the browser of the user device, and may be opened natively on the local client. In another example, when an object is open on the user device, and the user attempts to open an unsafe object, this unsafe object may be sent to the rendering session but is still displayed safely on the local browser. However, when the user attempts to open safe objects, these may be rendered on the user device as well.

In certain example embodiments, the predetermined security criteria may be stored and available in a reputation database stored on the user device and/or the rendering session. The predetermined security criteria may include policy choices, reputation of all possible connections, and organization/personal overrides. The reputation database may also include an extensive reputation and function blocklist to prevent the renderer from being used as a relay for covert communications to and from the user device.

Further, the rendering session may separate the browsing history from the user device. The rendering session may allow the user to copy and paste links from the rendering machine to the user device. If accidentally copy/pasted into the browser of the user device, this would still avoid malware since the rendering function would intercept and redirect untrusted future requests to the rendering machine. This dualism between the browser of the user device and the rendering session may generate at least two separate web browsing history sources, which can be merged, managed, and/or retained.

At 605, the rendering session may be reset, either periodically or on command by the user, removing any compromising code, session identifiers, personal identity, communications history, and modifications of any kind. Alternately, the rendering machine may maintain one or more personas over time for a variety of purposes. Cookies and advertising IDs, and other ways trackers and advertisers track people, machines, organizations, and equipment may removed when the renderer is reset. Since this rendering environment may be strongly resistant to unauthorized changes, logging and correlation of what succeeded and/or failed may be retained as a directory of malicious hosts or code.

In various example embodiments, detained forensics of attacks may be created and analyzed on particular users, devices, locations, and organizations. In the examples above, the rendering device may be remote from the user, wherein an adversary would be unable to discern which rendering session is for which client. There may be a need to know which particular adversary is targeting which user with what methods. Some example embodiments may accommodate modes in which the remote renderer may safely fetch data using the client's identities, but then that data may still be transmitted to the remote renderer for execution. This enables a combination of a sandbox and endpoint targeting. With a traditional sandbox, the sandbox may be a data center or on a burner device, but may survey the world from the persona of a sandbox rather than an actual person, device, location, organization, operating system and human persona. Certain embodiments described herein allow a remote renderer to be seen by potential adversaries as a real IP in a functional environment with all of the attributes of an actual device, rather than of a sandbox in a lab or hosting center.

In addition to hostile software, hostile hardware, firmware, operating system code, and device drivers can support remote control, data exfiltration, code and data infiltration, and serve as a relay for other devices. Encryption can prevent a user from understanding what data has been shared from their device and how often. Some example embodiments described herein may enable a lockdown mode in addition to the renderer function. While in lockdown mode, a local device may communicate with the remote renderer that runs applications, but all internet communications from applications, hardware, firmware, operating system code, data exfiltration, code and data infiltration may be blocked. A location aware application may actively track the movements of a device, while linking that location information to a mobile advertising ID, IMEI, or other unique IDs. The renderer can prevent the applications from knowing where the user device is, prevent prompting a user for that information, and prevent use of environmental sensors. Further, communications may be actively blocked which are not strictly allowed and necessary to and from the local device. In addition, permanent cookies or advertising IDs or device-based tags may not be connected to the local device, and may be cleansed or kept as a longer term false persona for security purposes.

Some embodiments may allow a user or researcher to fully render all content (safe, unsafe, and unknown), as well as for the remote renderer to create forensics for all content, from all mirrors, from multiple places. This may allow researchers to determine if certain users are provided different content from others; some sites are safe all the time, some are malicious all the time, but some sites are a hybrid. Such a hybrid may be referred to as a bucket brigade mode, wherein the end device is used to collect the raw objects, but the user node does not process them. Thus, the protected device may be used to retrieve potentially harmful data, but not process or render it at all, and instead relay the data to the remote render both for rendering and for forensic analysis.

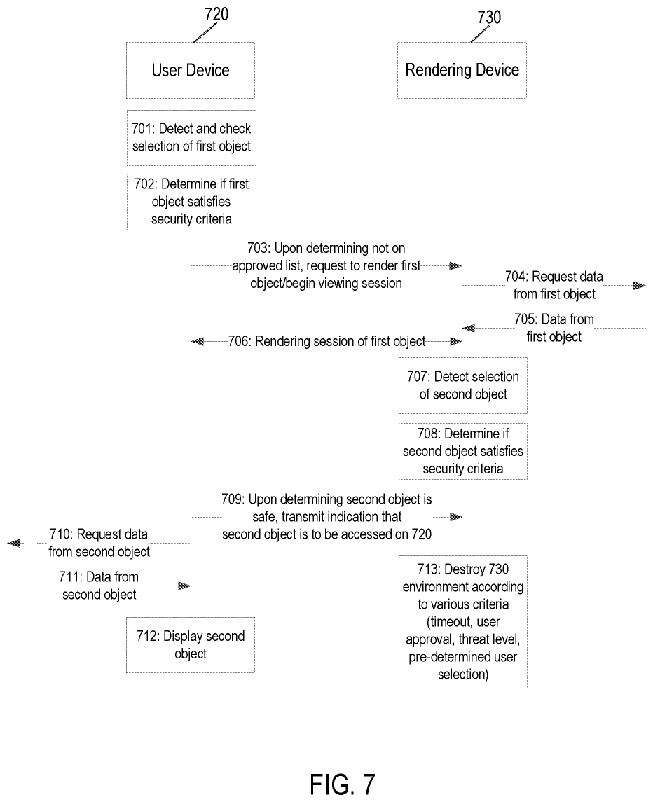

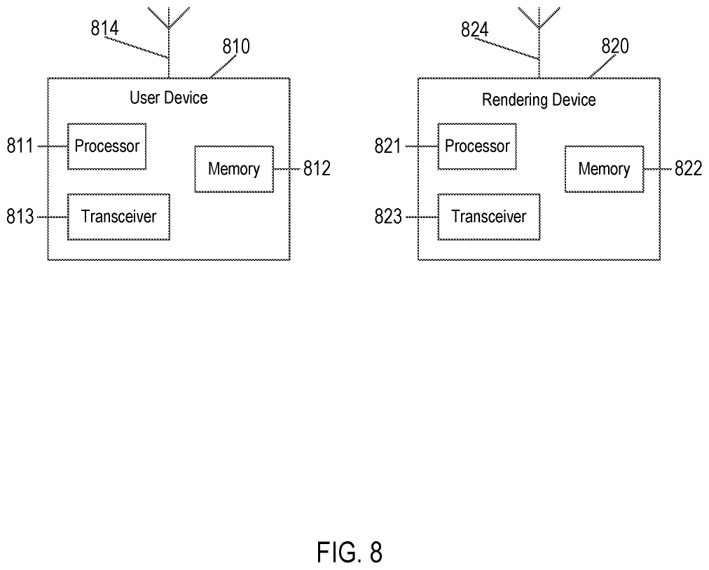

FIG. 7 illustrates an example of a signaling diagram depicting for implementing user device 720 with rendering device 730, similar to user device 810 and rendering device 820 illustrated in FIG. 8.

At 701, user device 720 may check for and detect a selection of a first object, such as a URI.

At 702, user device 720 may determine if the first object satisfies security criteria (e.g., the first object being in an approved list or a denied list).

At 703, upon user device 720 determining that the first object does not satisfy the security criteria, user device 720 may transmit to rendering device 730 a request to render the first object and/or to begin a viewing session (e.g., remote desktop protocol). Rendering device 730 may also create a rendering environment, which may include a search history library.

At 704, rendering device 730 may transmit a request for data to the first object, and at 705, receive a response from the first object containing data to render the first object.

At 706, rendering device 730 may transmit to user device 720 a rendering of the first object. In various example embodiments, the rendering may be performed using a The Onion Router (TOR) browser. In addition, rendering device may 730 add the first object to the search history library.

At 707, rendering device 730 may detect the selection of a second object. In some various embodiments, rendering device 730 may receive, via the rendering, an indication from user device 720 that the second object has been selected on user device 720. For example, the first object may be rendered as a website that contains hyperlinks to additional objects, including the second object. As a user browses the first object on user device 720, the user may select, open, or click on the second object, requiring leaving the first object and rendering of the second object.

At 708, rendering device 730 may determine if the second object satisfies the security criteria, which may be the same security criteria used at 702.

At 709, upon rendering device 730 determining that the second object satisfies the security criteria at 708, rendering device 730 may transmit an indication to user device 720 that user device 720 should access the second object, rather than being rendered by rendering device 730. In addition, rendering device 730 may add the second object to the search history library.

At 710, user device 720 may transmit a request for data to the second object, and at 711, receive a response from the second object containing data to render the second object. At 712, user device 720 may display the second object.

At 713, rendering device 730 may destroy the rendering environment, including the search history library, upon predetermined criteria being satisfied. In certain example embodiments, the predetermined criteria may include any of a timeout, user approval, threat level, pre-determined user selection.

User device 810 may include one or more of a mobile device, such as a mobile phone, smart phone, personal digital assistant (PDA), tablet, or portable media player, digital camera, pocket video camera, video game console, navigation unit, such as a global positioning system (GPS) device, desktop or laptop computer, single-location device, such as a sensor or smart meter, vehicle, aircraft, watercraft, fixed or mobile platform, tool, automation platform, or any combination thereof. Further, user device 810 and rendering device 820 may be one or more of a citizens broadband radio service device (CBSD).

Rendering device 820 may include one or more remote computers, virtual machines, processes, as well as processes on the protected machine. Furthermore, rendering device 820 may be implemented as one or more remote instances, which are not on the same device as the client, as more than one remote instance, more than one platform performing different functions or constructing a scalable parallel architecture, or as a service running locally on the protected device with some appropriate isolation mechanisms. When the output of rendering device 820 is intended for machine consumption, the output of rendering device 820 may include object observables, hashes and checksums, perceptual hashes, cryptographic checksums, file attributes, contextual topics and categories, forensic observations, associated communications/activities and the like. Rendering device 820 may execute code designed to penetrate, compromise, identify, geolocate, characterize, tag, or plant code on a potential victim's machine. Rendering device 820 may be partially or completely compromised over time; thus, rendering device 820 may need to be re-spawned with a virgin machine periodically. Furthermore, there are secondary characteristics of the knowledge of rendering device 820 which need to be hidden from the renderer since they may be partially or fully compromised, such as the IP address, location, environment, device characteristics, and identity of any users of rendering device 820.

Furthermore, secondary knowledge of the client machine such as browser version number, resolution, and other characteristics which could be used to sub-nuance the nature/platform/hardware/firmware/software/identity/location of the protected client may also be isolated from the renderer since it may be compromised. Rendering device 820 may communicate with a smart agent so that fetches of data may occur at either the client end or the render end depending on risk/trust and operational mode. Rendering device 820 may receive requests from the smart agent on a client or from other processes to fetch and render content not considered safe. Conversely, rendering device 820 may check subsequent user selections and redirections, which are deemed safe back to the smart agent for fetching. For example, ultra safe modes may exist in which all fetches and renders are performed on the renderer so to prevent a client from being exposed to external content, code, media, or other materials. In an example, the smart agent may perform fetches, while rendering may be performed on the renderer. The renderer may support local storage or remote storage in order to save internet content (assumed unsafe or dirty) in a way that is isolated from the protected client device. The renderer may manipulate this isolated storage, such as for filling out forms and the like. For forensic storage of evidence locally on the user's machine, this dirty storage may be encrypted or isolated in some manner to prevent inadvertent opening/execution on the local machine when stored on the user's local machine.

User device 810 and rendering device 820 may include at least one processor, respectively indicated as 811 and 821. Processors 811 and 821 may be embodied by any computational or data processing device, such as a central processing unit (CPU), application specific integrated circuit (ASIC), or comparable device. The processors may be implemented as a single controller, or a plurality of controllers or processors.

At least one memory may be provided in one or more of user device 810 and rendering device 820, as indicated at 812 and 822. The memory may be fixed or removable. The memory may include computer program instructions or computer code contained therein. Memories 812 and 822 may independently be any suitable storage device, such as a non-transitory computer-readable medium. The term “non-transitory,” as used herein, may correspond to a limitation of the medium itself (i.e., tangible, not a signal) as opposed to a limitation on data storage persistency (e.g., RAM vs. ROM). A hard disk drive (HDD), random access memory (RAM), flash memory, or other suitable memory may be used. The memories may be combined on a single integrated circuit as the processor, or may be separate from the one or more processors. Further, the computer program instructions stored in the memory, and which the processors, may process, may be any suitable form of computer program code, for example, a compiled or interpreted computer program written in any suitable programming language.

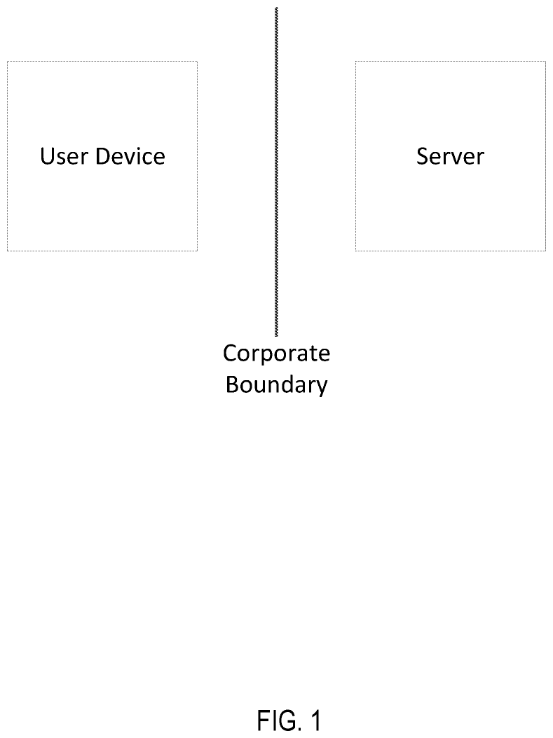

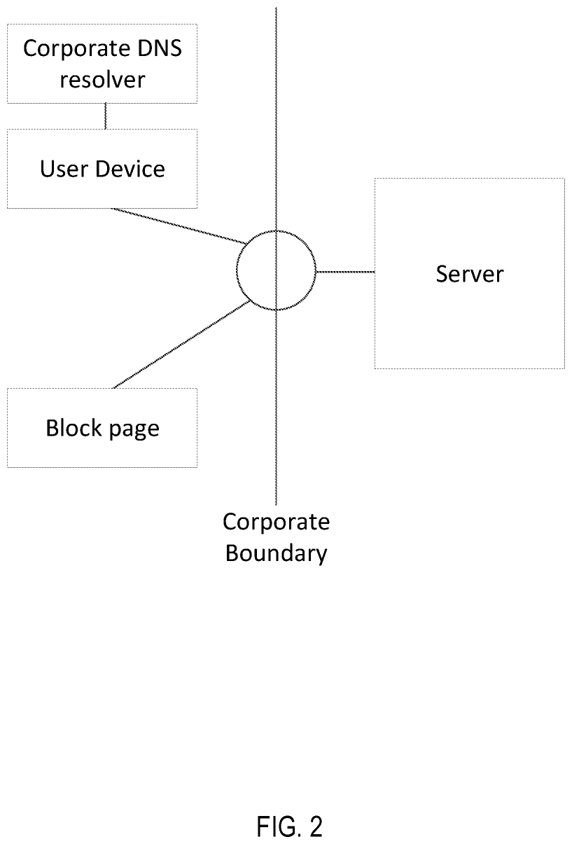

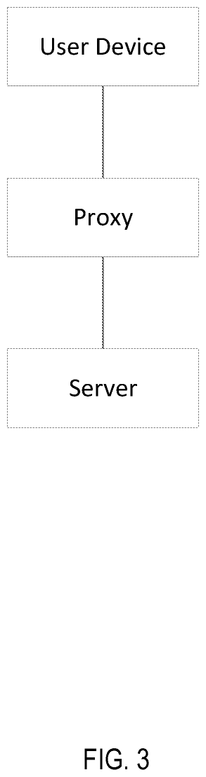

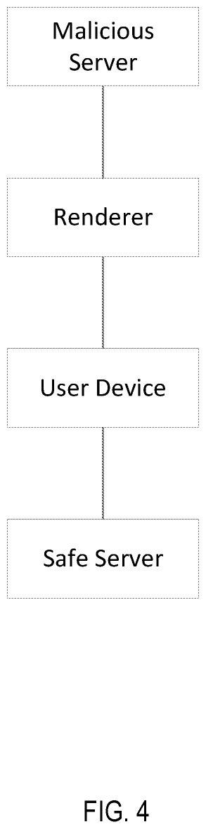

Processors 811 and 821, memories 812 and 822, and any subset thereof, may be configured to provide means corresponding to the various blocks of FIGS. 1-7. Although not shown, the devices may also include positioning hardware, such as GPS or micro electrical mechanical system (MEMS) hardware, which may be used to determine a location of the device. Other sensors are also permitted, and may be configured to determine location, elevation, velocity, orientation, and so forth, such as barometers, compasses, and the like.

As shown in FIG. 8, transceivers 813 and 823 may be provided, and one or more devices may also include at least one antenna, respectively illustrated as 814 and 824. The device may have many antennas, such as an array of antennas configured for multiple input multiple output (MIMO) communications. Other configurations of these devices, for example, may be provided. Transceivers 813 and 823 may be a transmitter, a receiver, both a transmitter and a receiver, or a unit or device that may be configured both for transmission and reception.

The memory and the computer program instructions may be configured, with the processor for the particular device, to cause a hardware apparatus (e.g., user device 810 and rendering device 820) to perform any of the processes described above (i.e., FIGS. 1-7). Therefore, in certain example embodiments, a non-transitory computer-readable medium may be encoded with computer instructions that, when executed in hardware, perform a process such as one of the processes described herein. Alternatively, certain example embodiments may be performed entirely in hardware.

In certain example embodiments, an apparatus may include circuitry configured to perform any of the processes or functions illustrated in FIGS. 1-7. As used in this application, the term “circuitry” may refer to one or more or all of the following: (a) hardware-only circuit implementations (such as implementations in only analog and/or digital circuitry), (b) combinations of hardware circuits and software, such as (as applicable): (i) a combination of analog and/or digital hardware circuit(s) with software/firmware and (ii) any portions of hardware processor(s) with software (including digital signal processor(s)), software, and memory (ies) that work together to cause an apparatus, such as a mobile phone or server, to perform various functions), and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Partial Glossary

| | |
|---|---|
| AI | Artificial Intelligence |
| CNAME | Canonical Name |
| CPU | Central Processing Unit |
| CSV | Comma-Separated Values |
| DNS | Domain Name System |
| DoH | Domain Name System over HTTPS |
| FTP | File Transfer Protocol |
| GPS | Global Positioning System |
| HDD | Hard Disk Drive |
| HREF | Hyperlink Reference |
| HSTS | HTTP Strict Transport Security |
| HTML | HyperText Markup Language |
| HTTPS | Hypertext Transfer Protocol Secure |
| ID | Identifier |
| IDPS | Intrusion Detection and Prevention System |
| IMEI | International Mobile Equipment Identity |
| IP | Internet Protocol |
| MAID | Mobile Advertising Identifier |
| MITM | Man-in-the-Middle |
| MD | Message-digest |
| OLE | Object Linking and Embedding |
| RAM | Random Access Memory |
| RDP | Remote Desktop Protocol |
| RTF | Rich Text Format |
| SHA | Secure Hash Algorithm |
| SMB | Server Message Block |
| SMIME | Secure/Multipurpose Internet Mail Extensions |
| SRC | Source |
| SSL | Secure Sockets Layer |
| Tor | The Onion Router |
| URI | Uniform Resource Identifier |
| URL | Uniform Resource Locator |
| VM | Virtual Machine |
| VNC | Virtual Network Computing |

We claim:

1. A method, comprising:
detecting, by a computing device, a selection of a first object by a user;
transmitting, by the computing device, a request to a rendering device to render the first object and begin a viewing session; and
receiving, by the computing device, a rendering of the first object from the rendering device.

2. The method of claim 1, further comprising:
determining, by the computing device, that the first object does not satisfy predetermined security criteria.

3. The method of claim 1, further comprising:
determining, by the computing device, that the first object is not included in a list of approved objects.

4. The method of claim 1, further comprising:
detecting, by the computing device, a selection by the user of a second object within the rendering of the first object.

5. The method of claim 4, further comprising:
determining, by the computing device, that the second object is in a list of approved objects;
transmitting, by the computing device, an indication to the rendering device that the computing device is to render the second object;
requesting, by the computing device, data from the second object;
receiving, by the computing device, data from the second object; and
displaying, by the computing device, the data received from the second object.

6. The method of claim 4, further comprising:
determining, by the computing device, that the second object is not in a list of approved objects;
transmitting, by the computing device, an indication to the rendering device that the rendering device is to render the second object;
receiving, by the computing device, a rendering of the second object from the rendering device; and
displaying, by the computing device, the rendering of the second object.

7. The method of claim 4, further comprising:
determining, by the computing device, that the second object is in a list of prohibited objects;
transmitting, by the computing device, an indication to the rendering device that the rendering device is to render the second object;
receiving, by the computing device, a rendering of the second object from the rendering device; and
displaying, by the computing device, the rendering of the second object.

8. The method of claim 4, further comprising:
determining, by the computing device, that the second object is not in a list of prohibited objects;
transmitting, by the computing device, an indication to the rendering device that the computing device is to render the second object;
requesting, by the computing device, data from the second object;
receiving, by the computing device, data from the second object; and
displaying, by the computing device, the data received from the second object.

9. The method of claim 1, wherein the rendering is performed with an onion (TOR) browser.

10. The method of claim 1, further comprising:
adding, by the computing device, at least one of the first object and the second object to a search history library.

11. A method, comprising:
receiving, by a computing device, a filetype decomposed from a rendering device; and
rendering, by the computing device, the decomposed filetype.

12. The method of claim 11, wherein the decomposed filetype does not contain executable scripts or macros.

13. The method of claim 11, further comprising:
transmitting, by the computing device, a request to the rendering device to store the decomposed filetype in a non-decomposed format.

14. The method of claim 11, wherein the request indicates the storage is to be performed with at least one of segregation or encryption.

15. A method, comprising:
receiving, by the computing device, a rendering from a rendering device, wherein the rendering comprises at least one service; and
terminating, by the computing device, a local service on the computing device that corresponds with the at least one service of the rendering device.

16. The method of claim 15, wherein the at least one service comprises one or more of chat, messaging, voice of internet protocol, hypertext transfer protocol, file transfer protocol, TOR, email, webmail, simple mail transfer protocol, internet message access protocol, and post office protocol, or other file sharing method.

17. The method of claim 15, further comprising:
terminating, by the computing device, at least the communications associated with the terminated services.

18. A method, comprising:
transmitting, by a computing device, a request to a rendering device to render a first object and begin a viewing session;
receiving, by the computing device, data from the first object;
transmitting, by the computing device, the data from the first object to the rendering device; and
receiving, by the computing device, a rendering of the first object from the rendering device.

19. The method of claim 18, further comprising:
detecting, by the computing device, a selection of the first object by a user; and
requesting, by the computing device, data from the first object.

20. The method of claim 18, wherein the data comprises at least one of content, downloads, applications, scripts, pointers, application programming interface calls, and other code.
